(19) United States
(12) Patent Application Publication
(10) Pub. No.: US 2022/0087000 A1
(43) Pub. Date: Mar. 17, 2022

(54) Ionic Threading Apparatus

(71) Applicant: Luis Cardozo, Fremont, CA (US)

(72) Inventor: Luis Cardozo, Fremont, CA (US)

(21) Appl. No.: 16/988,485

(22) Filed: Sep. 17, 2020

(51) Int. Cl. H05H 1/18; F03H 1/00; H05H 1/54

(52) U.S. Cl. CPC H05H 1/18; F03H 1/005; F03H 1/0043; H05H 1/54; F03H 1/0056

(57) ABSTRACT

This design processes free radical flows following physical principals that explain their movement conditioned by electromagnetic fields expressed in the convergence of induced field lines, in ways apart from existing designs. It describes specific means to obtain free radicals, process, and exhaust them within uniquely designed processing chambers.

The apparatus includes high frequency resonance transformers that exhaust free radicals into primary processing chambers generating a hot toroidal plasma, confined by an electromagnetic gate at one end of the chamber. The continuous injection of free radicals induce an increase in pressure and temperature that result in velocities greater than thermal electron velocity of the plasma. This velocity variance provides a current that generates a magnetic field component sufficient for conducing a plasma towards an exhaust port at the end of the chamber. As this plasma is exhausted, charge imbalances are realized, provoking additional accelerations of the free radicals.

The invention concerns the design for a non-polluting ionic propulsion engine. This novel ionic engine processes free radical flows following conventional physical principals that explain the movement of electrons conditioned by electromagnetic fields expressed in the convergence of induced field lines in ways apart from existing designs. It concerns specific means to obtain free radicals, process them within processing chambers uniquely designed, and accelerate and exhaust the free radical cloud into supplemental processing chambers until desired pressure, temperature and other specific conditions are achieved for desired propulsion.

The invention concerns the design for a free radical processing apparatus with integrated sources. The apparatus includes high frequency resonance transformers that exhaust free radicals into primary processing chambers. This flow is conducted into a hot toroidal plasma by their constant inflow and surrounding varying force electromagnets, located on the exterior of the chamber, with dedicated Faraday shielding, confined by an electromagnetic gate at one end of the chamber. These plasma sources work in conjunction with the varying force electromagnets to achieve and maintain the chamber's internal pressures. The continuous injection of free radicals induce an increase in pressure and temperature that result in velocities greater than thermal electron velocity of the plasma. This velocity variance provides a current that generates a magnetic field component sufficient for conducing a plasma towards an exhaust port at the end of the chamber, allowing controlled discharges of the pressurized plasma. As this plasma is exhausted a charge imbalance within the plasma is realized, provoking additional accelerations of the free radicals as they exhaust.

### FIELD OF THE INVENTION

This invention relates generally to the field of free radicals, and to apparatus and methods for processing them.

### INVENTION BACKGROUND

This invention relates to the field of systems for the acceleration of free radicals in such a manner that they develop propulsion potential, and to the apparatus and methods for processing them. Specifically, this invention pertains to an ion engine with specifically placed ion emitters that create a continuous and dedicated flow of free radicals inside specialized processing chambers. This flow forms a toroidal ionic cloud, which accelerates the free radicals until optimal conditions are obtained for their release into additional processing chambers. The free radical flows are reprocessed within these supplemental chambers in the same way as in the primary chambers, forming a larger toroidal cloud, resulting in further accelerations of these free radicals. These are exhausted into further processing chambers, or production, once ideal internal conditions are obtained.

The flow of free radicals is generated from a designed bank of pin-shaped ion emitters. This processing design is engineered to function in ambient conditions and is comprised of a dedicated array of a direct or alternating current power source coupled to a plurality of high frequency resonance transformers, primary and complimentary chambers with means to confine the free radicals, with dedicated Faraday Shields. This apparatus is designed to run continuously without any fuel other than an electrical power source, which can be renewable. This engine is designed to produce a wide range of momentum, from low-level in atmospheric conditions where ambient gases are ionized and accelerated, to higher-level in extra-atmospheric conditions, as a function of the emitters and number of chambers that process the free-radical streams.

The design for this apparatus may include complementary components to the emitters and processing chambers. Such as those that would assist the control and monitoring of these free radicals, like supplementary banks of varying force electromagnets to assist in the formation of toroidal flows or as magnetic gates to supplemental processing chambers, Faraday cages, and those systems or methods necessary to monitor internal environmental conditions. The chamber may be lined with a plasma confinement layer, which can be constructed from ceramic material, with supporting Faraday cages to control free radicals that could escape.

### SUMMARY OF THE INVENTION

The design of this apparatus includes investigation of other ionic systems, particularly those that utilize ionic principles following conventional physical principals, have few or no moving parts and use no other fuel except electrical power supplies, which may be renewable, or those integral to ambient conditions.

As compared to other designs, this novel apparatus has specific differences in purpose, design, and construction that underscore differences in the physical constitution of these devices to our design, and in consideration of the patterns of the flow of electrons and free radicals as a means of managing their momentum. These marked differences are underscored in each of the engine's main components. The designed bank of emitters. The design of the processing chambers that allows achievement of optimized metrics prior to the exhaust of the plasma cloud. The design of an exhaust port that contributes to the acceleration of these free radicals. And the subsequent processing in purposely designed reprocessing chambers for further acceleration.

This device stands separate from other art and natural conditions in treating electrons and ions. Because it treats these radicals independently from each other, this device benefits from the effects of accumulation of potentials normally impeded by a state of quasi neutrality seen under natural conditions, like in the ionosphere, and other art, in plasmas from fluorescent tubes to Tokamaks. Quasi neutrality describes the apparent charge neutrality of a plasma. Additionally, the plasma may give rise to localized disruptions in the form of charged regions and electric fields, and plasma holes. These conditions are detrimental, with multi-polar vortexes observed. Existing art is also subject to additional harmful conditions that are associated with these localized disruptions, the generation of runaway electrons. These are considered detrimental, especially in cases of large-scale plasmas, as seen in Tokamaks. Electrons may be subjected to unlimited accelerations under conditions of strong electric fields, reaching several hundred MeV. This condition may pose unique harm in energy generation. In Tokamaks, collisions between relativistic runaway electrons and low energy electrons cause this population to undergo geometric growth, known as a runaway-electron avalanche. It is thought that in large tokamaks, a runaway electron can cause severe damage through the emission and absorption of electromagnetic waves through resonances. Currently, extensive theoretical and simulation studies of runaway electron physics are in the process of development for its study in tokamaks, including their generation, diffusion, and radiation.

The presented art addresses this problem by allowing for the controlled and uniform processing of these accelerations. Because quasi-neutrality states are not sought, the disruptions and damages associated with other art are averted.

Also, this device stands separate from other art in that they subject their emitters to differences in the oxidation dynamics, which lead to morphological changes of the emitter's exposed electrode edge. This affects the dynamics of the micro-discharges and the main integral electrical characteristics like power input, charge amplitude, the shape of the charge—voltage cycle plot. Because our novel device processes electrons and ions separately in non-atmospheric conditions, there is no degradation on the electrodes' surface and, consequently, of the medium's electrical characteristics.

Lastly, our device differs from others in the processing of electrons and ions at scale, like Tokamaks. These have to rely on specifically developed hardware to ensure a toroidal flow, with a specially placed cathodic axes running through the center to attract and help maintain a toroidal plasma flow. Our device relies on the emissions of arranged electrodes, forming a torus as a consequence of this placement. The lack of hardware along its axis allows the placement of an exhaust gate.

Regarding the bank of emitters. Our apparatus centers on a specified design of emitters that feed electrons or free radicals into a processing chamber. The design includes emitter composition, quantity, placement, and orientation. Composition. FIG. 1 is a schematic representation of the high frequency resonance transformer. Placement includes Quantity and Orientation. The quantity of the emitters is driven by a desired optimization of the interactions between free radicals and the desired application of its final output. The emitters are placed in such a way that they are aligned parallel to each other and towards the processing chambers' axis, along its sides, orientated in such a way that the emission's angle is offset from the axis in the same angle θ. This optimization is directly related to the chamber's proportions.

This optimized placement attains first the number of emitters in such a way that they best achieve and maintain desired environmental conditions, and secondly, with the optimal orientation of emissions so as to best assist in the development of a toroidal plasma cloud critical to the administration of the free radicals and in obtaining conditions for exhaust. FIG. 2a is a schematic representation of the primary processing chamber. It shows the bank of HFRT with the placement and alignment described, electromagnetic gate by the exhaust port, free-radical inflows from bank of HFRT and the toroidal cloud they form, and exhaust vector towards a supplementary chamber. FIG. 2b is a cross-sectional representation of 2a, representing free-radical inflows and angle θ. FIG. 2c is a cross-sectional representation of 2a representing the formation of the toroidal cloud along the chamber's longitudinal axle.

The orientation of the HFRT described is expressed in FIGS. 2a, 2b, and 2c, where the flows that emanate from these emitters are represented by an emission cone, with one side on the chamber's radial segment XO and offset by the emission cone's central angle θ. This central angle θ is a function of the intensity of the current applied to the emitter, and to the number of free radicals emitted, as well as to the processing chamber's radius and the measured emission cord.

The design of the emitter is represented in FIG. 1, showing internal components, and the placement and specific orientation represented in FIGS. 2a and 3. The design for the processing chambers is represented by FIGS. 2a and 3. These are designed in such a way that they are similar bodies as it regards proportions and placement of components. This design allows for exponential formulae to determine additional processing.

The design for the exhaust is represented in FIGS. 2a and 3. These gates, composed of varying force electro magnets, are designed in such a way that their output balances the chamber's internal charge differentials and maintain, with the assistance of specific devices and methods, critical internal conditions as to maintain a constant exhaust of free radicals.

In FIG. 2a, this device's exhaust is realized by the use of High Frequency Resonance Transformers (100) to emit free radicals into a processing chamber (200), where these inflows are confined to toroidal clouds (204 and 205) by their own potential and assisted by a bank of varying-force electromagnets and electromagnetic gate (202 and 203), where, after optimal conditions are obtained, are exhausted into supplemental processing chambers (300). Here, the process is repeated at exponential scale (FIG. 3). A key component of this devise is the use of complementary processing chambers. First, the inflows into these chambers follows a toroidal shape, allowing additional braiding of the free radicals, which increases internal pressures and reduces reliance on external electromagnetic banks. Additionally, the placements of the primary processing chambers about secondary ones can be optimized in such a way that the charges generated by each primary chamber complements the use of the varying-force electromagnet bank, further mitigating massif apparatus and reducing energy loss.

### BRIEF DESCRIPTION OF THE DRAWINGS

This invention is described with particularity in the appended claims. The above and further advantages of this invention may be better understood by referring to the following description taken in conjunction with the accompanying drawings, in which:

FIG. 1 is a schematic representation of the high frequency resonance transformer (HFRT)

FIG. 2a is a schematic representation of the distribution of the HFRT units around the primary plasma chamber, their emissions and the orientation of this flow depicted by a representation of a conical distribution path. In this illustration, the toroidal cloud will have a clockwise rotation.

FIG. 2b is a cross sectional representations of FIG. 2a. Illustrating the ionic path from an emitter into the chamber, the base's radius r a function of the varying-force free radical emitters.

FIG. 2c is a cross sectional representations of FIG. 2a. Illustrating how the emissions, in conjunction with supplemental varying-force electromagnets (all not shown), interact to form the toroidal cloud, in this case illustrating a counter-clockwise rotation.

FIG. 3 is a representative schematic of how the primary plasma chambers are distributed around the secondary plasma chambers.

FIG. 4 is a graphical illustration of the expected ranges of inflows of electrons per second given a specific number of HFRT and chamber dimension.

FIG. 5 is a graphical illustration of the expected ranges of mass processed per second given a specific number of HFRT and chamber dimension.

FIG. 6 is a graphical illustration of the expected ranges of charge emitted per second given a specific number of HFRT and chamber dimension.

FIG. 7 is a graphical illustration of the expected ranges for charge differentials at different chamber intervals given a specific number of HFRT and chamber dimension.

### DETAILED DESCRIPTION

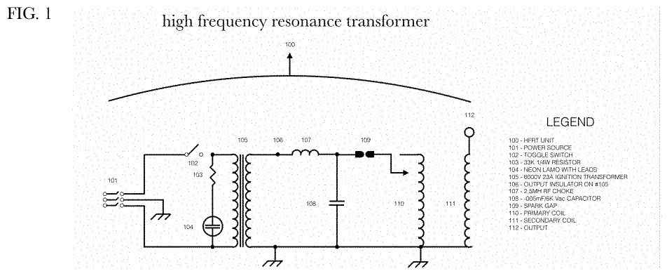

FIG. 1—Schematic representation of the high-frequency resonance transformer that continuously generates the free radicals that create the ionic flows that are subjected to increased pressures in such a way that accelerates their flow and increases their temperatures. The free radicals are driven directly into the plasma chamber. Their number, a function of the carrying materials and function of device, can be set as a constant N=1014 sm−3 per emitter. The charged particles, subjected to increased pressures stemming from the continuous inflow of additional free radicals, create a toroidal plasma within the chamber.

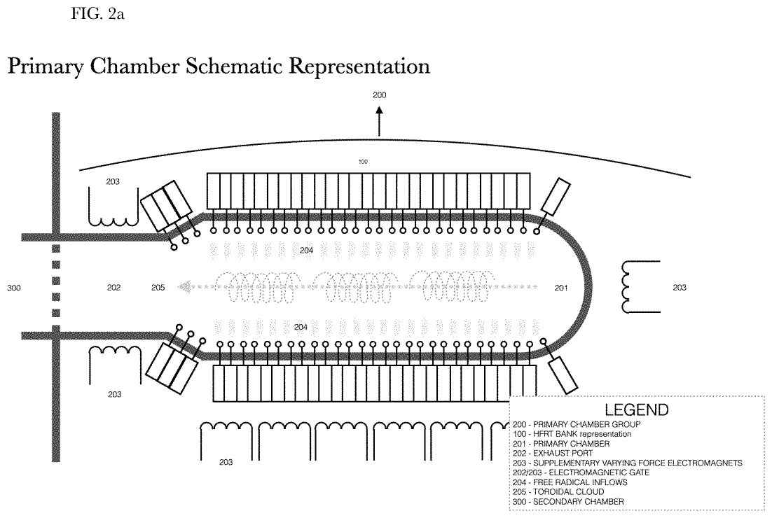

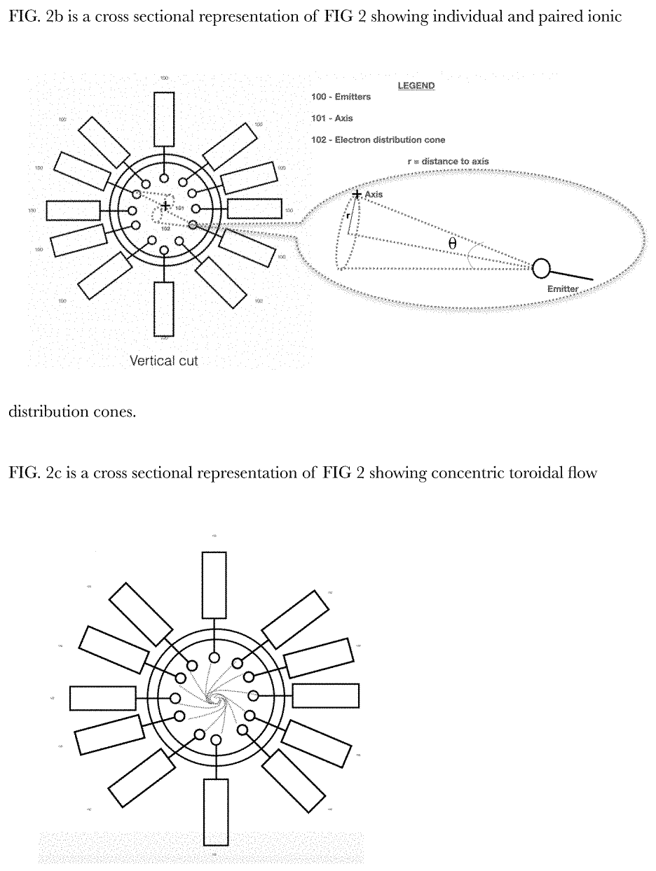

FIG. 2a Representation of the HFRT distribution about the primary plasma chambers.

The plasma chamber may contain additional control varying force electromagnets (not all shown) to allow the direct control of internal pressures, as well as Faraday Shields (not shown), to act as controls to free radicals escaping the chamber. The plasma chambers may be formed from metallic materials such as aluminum or refractory metal, or dielectric materials such as quartz. The chamber may be lined with a plasma confinement layer, which can be constructed from ceramic material. The High-Frequency Resonance Transformers are mounted to the tubular chamber normal to its longitudinal axis in such a way that the emitter penetrates the chamber wall and the ionic streams are delivered towards the chamber's axis.

However, it should be noted that the number and distributions of the HFRTs are not limited to the illustration, but are dependent on the particular use case of the device. The overall number of HFRT is a function of an optimization algorithm that obtains the best possible flow in terms of internal pressures and temperatures in such a way that they best feed into secondary and supplementary chambers to obtain desired ionic velocities.

The emitters should be aligned in such a way that the axis of the emitted free-radicals is a distance r from the axis of the chamber. The distance r is defined as the radius of the base of an emission cone formed by the emitted ions for each of the HFRT. This alignment should be replicated by each HFRT in the chamber, in such a way that the free radicals conform either a clockwise or counter-clockwise toroid.

FIG. 2b is a cross sectional representations of FIG. 2a. Illustrating the conic path from an emitter into the chamber, the base's radius r a function of the varying-force free radical emitters.

FIG. 2c is a cross sectional representations of FIG. 2a. Illustrating how the emissions, in conjunction with supplemental varying-force electromagnets (all not shown), interact to form the toroidal cloud, in this case illustrating a counter-clockwise rotation.

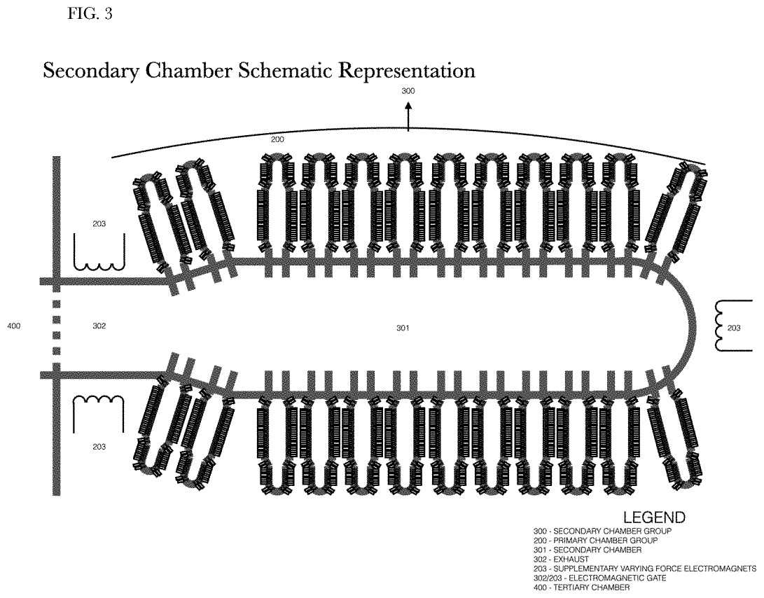

FIG. 3—Represents the distribution of the primary chambers about secondary chambers. These chambers are fed by the outflow of primary chambers and treat the aggregated ionic flow in much the same way, accelerating and increasing the pressure by further braiding of the ionic flow and producing a secondary toroidal plasma that exits the chamber once desired the desired conditions are achieved. The schema can also be applied to n iterations to obtain desired results.

Formulations

The design, as expressed in the figures, allows for an intelligent approach to the optimal number of free radical expected from each emitter. Under optimal conditions, a conductor, in this case copper, allows one free electron per copper atom. Therefore, in a unit volume, the number of free electrons is the same as the number of copper atoms per cubic meter. The number of copper atoms in a unit volume of copper provides the density of free electrons in the same unit volume. Formula 1 allows to determine this.

$$N = \frac{1 {e}^{-}}{atom} \times \frac{Avogadro}{mol} \times \frac{1 mol}{63.54 g} \times \frac{1 , 000 g}{kg} \times \frac{8.8 \times {10}^{3} kg}{{m}^{3}} = 8.34 \times {10}^{\hat{}} 28 {e}^{-} / {m}^{3} \qquad FORMULA 1$$

Adjusting for volume of a typical conductor, the electrons in a copper conducer of meter length and 2.58 mm diameter is approximately 1.09×10\hat{ }23.

Formulations of the number of free radicals in a processing chamber is a function of the different mediums' densities, volumes, specific environmental conditions, and placements and ratios of free radical emitters and process chambers. Given a specific number of emitters in a processing chamber of unity diameter, length of 3 diameters, and emitter separation of 0.02 m, and an emission-cone base of 0.02 m, we can formulate the expected number of free radicals exhausted per second after a particular number of processing chambers and specific density differentials, as the free radicals traverse different mediums.

Given the emission cone base of 0.02 m, provides the following means to determine θ.

$$Θ = \frac{cord}{radius} + 90.00 = 90.04$$

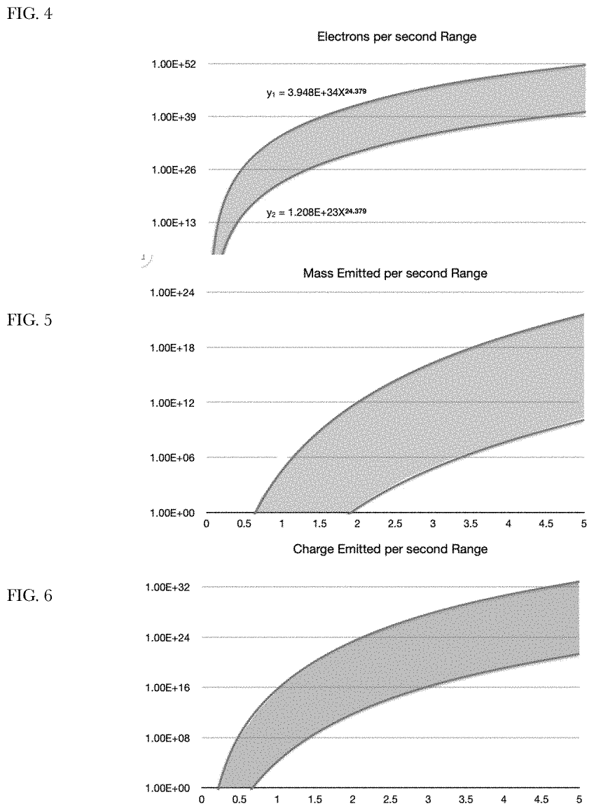

The following graphs are representation of per second ranges as a function of different densities in different mediums. The range is depicted by the shaded region between the functions. In FIG. 4, the function y2, represents flows at Drift velocity, 1.16×10⁻⁰³ m/s, the function y1 represents flows when Drift velocity approximate Charge velocity. FIG. 4 is a representation electrons per second.

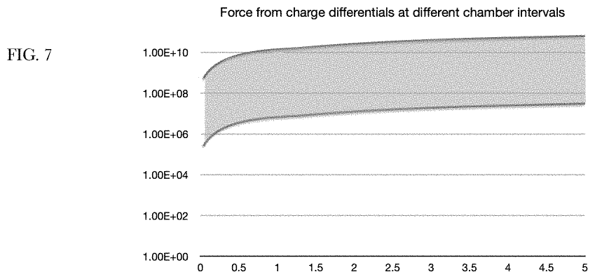

These formulations provide the basis for the determination of optimal design considerations for propulsion according to this methodology. By vectorizing the expected number of free radicals by their mass and charge, approximately 9.11×10⁻³¹ Kg and 1.60×10⁻¹⁹ Co, we can formulate, first, primary expected Force, FIG. 5, and second, expected additional accelerations driven by charge differentials, FIG. 6.

Regarding additional accelerations resulting from charge differentials. The system within the processing chamber, comprised of the individual charges of the free radicals rotating in the toroid cloud complemented by the bank of varying-force electromagnets located externally to the chamber and by the varying force electromagnetic gate, maintain charge differentials in balance while its gate is activated. Once the electromagnetic gate is opened, a charge differential is created, forcing the free radicals to exit through the exhaust. As these exit, a charge differential increases as they move towards the exhaust. Increasing from 6.18×10⁰⁶ in low density conditions, to 6.29×10¹⁰ Co in maximum density conditions. FIG. 7 represents this charge differential in a primary chamber, it represents range of additional accelerations that result in velocities greater than thermal electron velocity of the plasma. Charge differentials are considered to be exponential magnitudes superior in secondary and supplemental chambers given the increase in free-radical inflows and volumes.

1. An ion engine comprising:
A bank of dedicated ion emitters, renewable power bank that feed bank of emitters, electrically insulating processing chambers with exhaust channels, supplemental bank of varying force electromagnets, electromagnetic gates, Faraday Cages, and means of measurement and control of toroidal flows

2. An ion engine comprising:
A bank of dedicated ion emitters, renewable power bank that feed bank of emitters, electrically insulating processing chambers with exhaust channels, supplemental bank of varying force electromagnets, electromagnetic gates, Faraday Cages, and means of measurement and control of toroidal flows

3. An ion engine comprising:
A bank of dedicated primary processing chambers, power bank that feed primary processing chambers, special design that augments spins exhausted from primary processing chambers, electrically insulating secondary processing chambers with exhaust channels, supplemental bank of varying force electromagnets, electromagnetic gates, Faraday Cages, means of measurement and control of toroidal flows.

4. An ion engine comprising:
A bank of dedicated secondary processing chambers, power bank that feed secondary processing chambers, special design that augments spins exhausted from secondary processing chambers, electrically insulating tertiary processing chambers with exhaust channels, supplemental bank of varying force electromagnets, electromagnetic gates, Faraday Cages, means of measurement and control of toroidal flows

5. An ion engine comprising:
A bank of dedicated tertiary processing chambers, power bank that feed tertiary processing chambers, special design that augments spins exhausted from tertiary processing chambers, additional electrically insulating processing chambers with exhaust channels

6. Means for preparing a dense, hot toroidal plasma having a confining magnetic field with toroidal and poloidal components, comprising:
A bank of free radical sources distributed around the plasma chamber, electrically insulating processing chambers with exhaust channels, varying force electromagnets surrounding the plasma chamber, varying force electromagnets surrounding the plasma chamber as electromagnetic gates, Faraday shields.

7. Means for preparing a dense, hot toroidal plasma having a confining magnetic field with toroidal and poloidal components, in additional processing chambers, comprising:
A bank of primary processing chambers as free radical sources distributed around processing chambers, electrically insulating processing chambers with exhaust channels, varying force electromagnets surrounding a portion of the plasma chambers to assist and control Toroidal cloud, varying force electromagnets surrounding a portion of the plasma chamber to serve as electromagnetic gates, Faraday shields

8. The solid state AC switching power supply driving an AC current in the free radical sources, inducing a flow of ions directly inside the processing chamber that form a toroidal plasma, increasing the pressure of these particles, which are discharged under controlled conditions after target levels of pressure are attained.

9. A design and method for generating steady state confining current for a toroidal plasma exceeding the power dissipated in said plasma, comprising:
A bank of dedicated ion emitters as free radical sources distributed around the processing chamber, renewable power bank that feed bank of emitters as a solid state AC switching power supply comprising one or more switching semiconductor devices coupled to a voltage supply and having an output coupled to various free radical sources, electrically insulating processing chambers with opening at one end to serve as exhaust channels, supplemental bank of varying force electromagnets, electromagnetic gates, Faraday Cages, means of measurement and control of toroidal flows.
